(19) United States
(12) Patent Application Publication
(10) Pub. No.: US 2005/0054770 A1
(43) Pub. Date: Mar. 10, 2005

(54) Helicomimetics and stabilized lxxll peptidomimetics

(76) Inventors: Arno F. Spatola, Louisville, KY (US); Jackie B. Spatola, Louisville, KY (US); Anne-Marie Leduc, Lyon (FR)

Correspondence Address: David W Carrithers;Carrithers Law Office, One Paragon Centre, 6060 Dutchman's Lane Suite 140, Louisville, KY, 40205, US

(21) Appl. No.: 10/471,120

(22) PCT Filed: Mar. 11, 2002
(86) PCT No.: PCT/US02/07093

Related U.S. Application Data
(60) Provisional application No. 60/274,846, filed on Mar. 9, 2001.

(51) Int. Cl. C08H 1/00

(52) U.S. Cl. 525/54.1

(57) ABSTRACT

This invention pertains to the design and synthesis of molecules that can act as protein mimics. In particular this disclosure teaches the preparation of short, cyclic peptide sequences that can adopt a helical conformation and display a particular arrangement of amino acid side chains oriented in a specific arrangement to serve as a pharmacophore. A ring, formed by a disulfide bridge between pairs of cysteine residues, maintains the helical structure. When the cysteines are arranged in a pattern of i to i+3 as illustrated in FIG. 1, and when the first cysteine is of the D-configuration, and the second cysteine is of the L-configuration, the helical arrangement is especially stabilized. A preferred version of this invention involves a pentapeptide sequence of general structure known as the NR Box, stabilized by a side chain to side chain disulfide bridge formed from the two cysteines.

This application is a United States non-provisional application which claims the benefit of U.S. Provisional Application Ser. No. 60/274,846 filed on Mar. 9, 2001, the teachings of which are hereby incorporated by reference.

### BACKGROUND OF THE INVENTION

1. Field of the Invention

The present invention relates to the design and synthesis of a new class of stabilized peptide structures that are useful as mimics of the alpha helical structure ubiquitous in proteins.

2. Description of the Related Art

Steroids, along with other lipophilic hormones such as the retinoids and vitamins, bind to members of the nuclear-receptor superfamily. These ligands modify the DNA-binding and transcriptional properties of these receptors, resulting in the activation or repression of target genes. Ligand binding induces conformational changes in nuclear receptors and promotes their association with a diverse group of nuclear proteins, including SRC-1/p160, TIF-2/GRIP-1 and CBP/p300 which function as co-activators of transcription. A short sequence motif LXXLL (where L is leucine and X is any amino acid) present in RIP-140, SRC-1 and CBP is necessary and sufficient to mediate the binding of these proteins to liganded nuclear receptors. The ability of coactivators to bind the estrogen receptor and enhance its transcriptional activity is dependent upon the integrity of the LXXLL motifs and on key hydrophobic residues in a conserved helix (helix 12) of the estrogen receptor that are required for its ligand-induced activation function. Thus the LXXLL motif is a signature sequence that facilitates the interaction of different proteins with nuclear receptors, and is thus a defining feature of a new family of nuclear proteins (Heery, 1997).

These compounds are intended as protein mimics and thus could find numerous applications, and especially for inhibition of protein-protein interactions where at least one of the proteins displays a helical segment as a prominent feature in terms of its tight binding to another protein. Where the protein-protein interaction is critical to a biological function, as is often the case, then by retarding or preventing this interaction through the intervention of the helicomimetic (helix protein mimic), this compound can serve as a useful drug candidate in the event of a pathologic process such as cancer or stroke, or other instances such as transcription mediated by nuclear receptors and their cognate macromolecules.

### SUMMARY OF THE INVENTION

This invention includes helix stabilized compounds that contain the so-called NR Box, found in a large number of Nuclear Receptor Coactivator Proteins. The NR Box sequence, consisting of Leu-Xxx-Yyy-Leu-Leu within a longer peptide, is found in both coactivator proteins and also in certain nuclear receptors themselves. In the case of the Androgen Receptor, this sequence is varied to include Phe-Xxx-Yyy-Leu-Phe and Phe-Xxx-Yyy-Leu-Trp, where Xxx and Yyy typically consist of two out of a rather large and diverse choice among the 20 common or natural amino acids.

By preparing synthetic variants of relatively short peptides and peptide mimics that contain the crucial hydrophobic amino acids, e.g., leucines, that maintain contact with the nuclear receptor, it is possible to prevent binding of the coactivator proteins to the nuclear receptors. This intervention prevents the receptor from its normal subsequent step of binding to DNA and thus also prevents the transcription of the DNA segment known os the Estrogen Response Element. This intervention has a similar pattern with respect to the other types of nuclear receptors, such as the androgen, progestin, glucocorticoid, mineralocorticoid, and the growing number of orphan receptors that have been shown to function in a biochemically equivalent manner. Thus, by the prevention of the normal receptor-coactivator interactions, we will be able to control such effects as DNA transcription and the related downstream events that are affected, such as cell growth and division. Thus these molecules represent a novel approach to the control of such diseases as breast cancer and prostate cancer. These forms of cancer are currently treated with such agents as tamoxifen and raloxifene that function as estrogen antagonists. But tamoxifen and raloxifene have been shown to bind to the normal steroid binding site, and not to the site occupied by the helical peptide LXXLL. Thus our peptides represent a novel and distinct approach toward the treatment of cancer through a new form of inhibition of nuclear receptor action.

In order for LXXLL peptides to bind to the receptor, it is believed essential that they do so in the form of an alpha helix conformation. Shorter linear peptides tend to adont random or β-sheet structures rather than helices. Various strategies have been used to induce helix folding including incorporation of α-alkyl amino acid residues such as Aib (aminoisobutyric acid) or Deg (diethylglycine). This approach may lead to unacceptably high hydrophobic character when matched with an LXXLL sequence. Other options include helix end capping and dipole stabilization, primarily useful for longer sequences.

The peptides of the instant invention are preferable to LXXLL linear sequences for several reasons. The first is that we and others have shown that short, linear peptides are not able to inhibit coactivator binding, at least to the extent our bioassays reflect this activity. Second, by including pairs of cysteine residues within the sequence, we are able to enhance the helical character of these peptides. The preferred method for doing so involves the incorporation of one D-cysteine in the sequence and one L-cysteine. It is important to note that other workers have generally found that this type of side chain to side chain cyclization does not yield a strongly helical sequence. Our studies have also demonstrated this trend. But our work also demonstrates that the cysteine bridges do in fact help stabilize this helical tendency when the cyclic peptide comes into contact with the nuclear receptor. This has been shown most clearly by a study of the interaction of one of our peptides (that one known as PERM-1 for peptidomimetic estrogen receptor modulator −1) with the ligand binding domain of the estrogen receptor (see the Figure showing the X-ray crystal structure by N. Chirgadze and coworkers). This finding is significant since it shows the ability of our synthetic peptide to adopt a clear helical conformation in the presence of its partner and to form a strong and stable interaction with the receptor.

Additionally, our peptides can easily be made selective to one or another of the multiple nuclear receptors by changing the structure of the amino acids in the flanking regions. Thus, as seen in Table I entitled “Peptide Analogs and their Ki values against ER alpha and ER beta”, it is apparent that by changes in amino acid composition, we are able to increase the binding toward ER alpha to a significant degree. Furthermore, this selectivity in preferred binding to a receptor is in most cases predictable through an examination of both the sequences of amino acids found in various naturally occurring coactivator proteins as well as by an examination of the receptor residues found in close proximity to the LXXLL binding sites. This is an important attribute of our cyclic peptide analogs since it means that we may retain the preferred small, cyclic helix-forming nature of our peptides and yet still embody the selectivity and specificity important to any useful drug.

For instance a preferred embodiment of a compound of the present invention comprises of the structure R1-(Xn)-D-Cys-Y-Y-L-Cys-(Xn)-R2, where R1 consists of H, an alkyl, aryl, acetyl, formyl, or other blocking or solubilizing group such as a polyethylene glycol (PEG) or other polyether moiety, linked to the N-terminal nitrogen through a carbon-nitrogen bond. Moreover, X consists of one or more natural or unusual amino acids, linked together in a chain from 0 to n in length, and Y consists of any natural or unnatural amino acid, usually of the L-configuration, and with two such amino acids that need not be identical, separating the pairs of cysteines to form an i to i+3 type of disulfide bridged unit. R2 consists of an OH, NH2, NHR, OR, or other blocking or solubilizing group such as polyethylene glycol (PEG) or other polyether moiety linked to the C-terminal carbonyl through an oxygen or carbon or nitrogen linkage, such as an amide group.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a structure of a side chain linked amide (a) and disulfide (b) bridges at (i,i+4) and (i, i+3) positions, respectively;

FIG. 2 is color a molecular modeling rendition of the structure of a helicomimetic peptide bound to a nuclear receptor; and

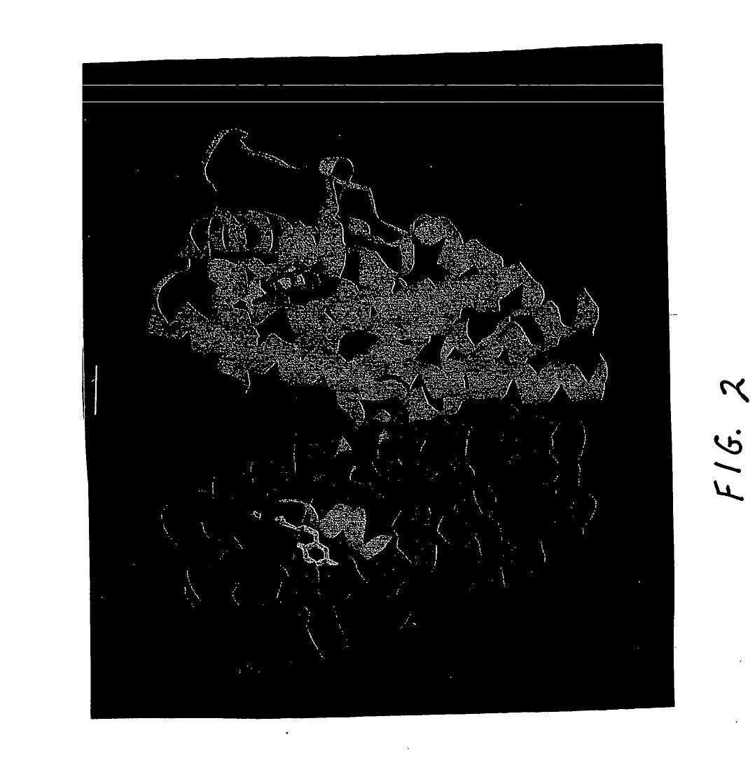

FIG. 3 is a black and white photocopy of FIG. 2.

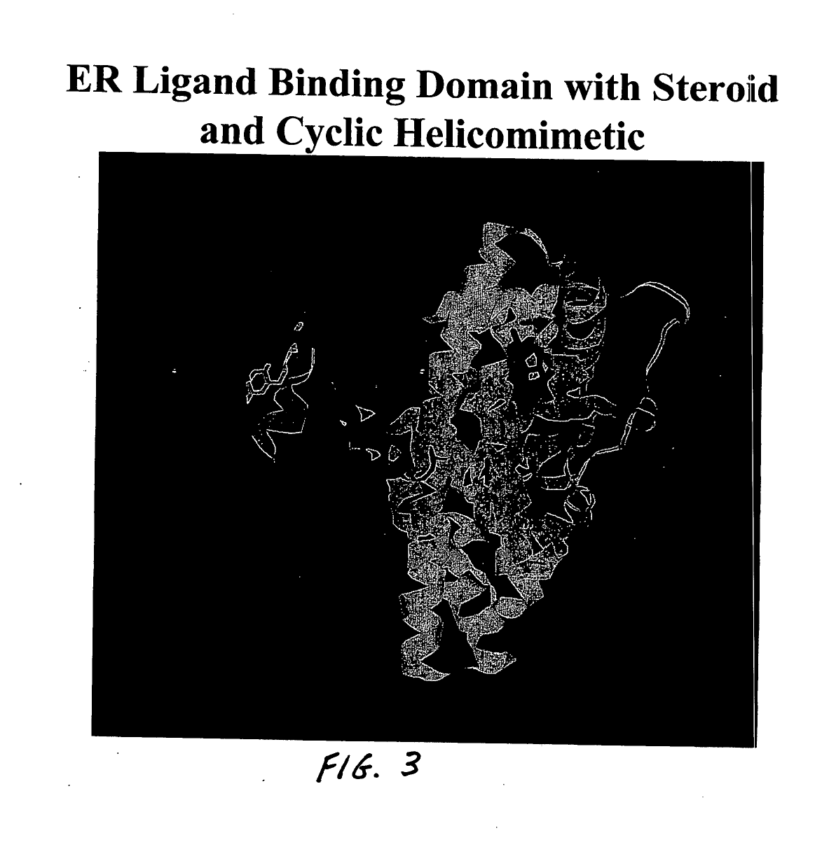

### DESCRIPTION OF THE PREFERRED EMBODIMENT

The preferred compound of this invention involves a cyclic peptide containing the LXXLL sequence. The cycle is formed through a side chain to side chain ring involving a monosulfide or disulfide bridge between pairs of cysteines, penicillamines, homocysteines, combinations of the foregoing, or other pairs of amino acids in which the side chains are linked with either one or two sulfur atoms. In a preferred embodiment, the peptide cycle is formed with a D-cysteine at the −2 position and an L-cysteine at the first Xxx residue to produce an i to i+3 ring. With this partial structure, such as -D-Cys-Ile-Leu-Cys-Arg-Leu-Leu-, the flanking residues attached at the N-terminal side of the D-Cys and at the C-terminal side of the Leu provide selectivity as inhibitors against one of several nuclear receptors. For example, in the case of the compound known as PERM-1, the Ki value against ER beta is approximately 390 nM, while its value against ER alpha is 25 nM. Thus this compound exhibits selectivity against the ER alpha receptor.

The compounds may also be modified by the attachment of elements designed to stabilize the structure, and to enhance bioavailability. For example, the N- and/or C-termini may be attached to polyethylene glycol (PEG) fragments, designed to enhance penetration through lipid membranes. Alternatively, other types of solubility enhancing bioconjugates may be used to assist in membrane permeability. Other modifiers can also be attached. For example, the TAT and related hydrophilic peptide sequences, derived originally from the HIV virus, have been demonstrated to assist in the delivery of peptides and other therapeutic agents into cells. These sequences, along with those known as antennapedia peptides, would be expected to provide a similar benefit for the delivery of these nuclear receptor antagonists into the cell and eventually to the nuclear compartment.

Another approach that has shown promise in enhancing peptide bioavailability is the replacement of one or more amide bonds with various backbone replacements. These may include pseudopeptides, with CH2S, CH2NH. CH═(CH, or N-methyl amide bond modifications, or can involve the substitution of an amino acid with more conformationally constrained variants such as alpha methyl and beta methyl substitutions. The replacement of cysteine by penicillamine (beta, beta-dimethyl cysteine) has been previously mentioned. This modification is able to reduce the flexibility of the disulfide ring and can enhance stability, potency, and selectivity, as has been documented in the case of the mu selective opioid analog known as DPDPE.

The major therapeutic benefit gained by the design and synthesis of coactivator antagonists is a more effective control of steroid receptor mediated transcriptional processes. Thus in diseases such as breast cancer or prostate cancer, certain hormone dependent tumors grow through the uncontrolled steroid-mediated transcription within the malignant cells. Effective therapeutics may me used in the assessment, treatment, and prevention of cancer. It is also important that these agents be selective so that undesired cell proliferation is prevented but such other benefits of estrogenic agonists such as prevention of osteoporosis should not be compromised. Control of transcription may be desired in order to help overcome one or more genetic malfunctions in an individual. It may also be anticipated that these novel antagonists can serve as diagnostic agents and as effective inhibitors in the case of various types of orphan nuclear receptors, whose functions have yet to be determined (Burris and McCabe, 2000).

Experimental (Peptide Synthesis)

The linear and cyclic peptides were synthesized using Boc-based Merrifield solid phase peptide synthesis using a anhydrous hydrogen fluoride for cleavage from the methylbenzhydryamine resin support to provide the targeted peptide amides. Scheme 1 summarizes the approach used for two cyclic variants. A lactam bridge between Glu, Lys was formed on the resin following base-mediated cleavage of the fluorenylmethyl-class protecting groups. In contrast, disulfide bridge formation was performed off-resin, with Tam's DMSO oxidation procedure providing the best results when using heated sulfoxide reagent.

Products were analyzed by CD, NMR spectroscopy, reversed phase high pressure liquid chromatography, and thin layer chromatography, and the expected structures confirmed with MALDI-TOF mass spectrometry.

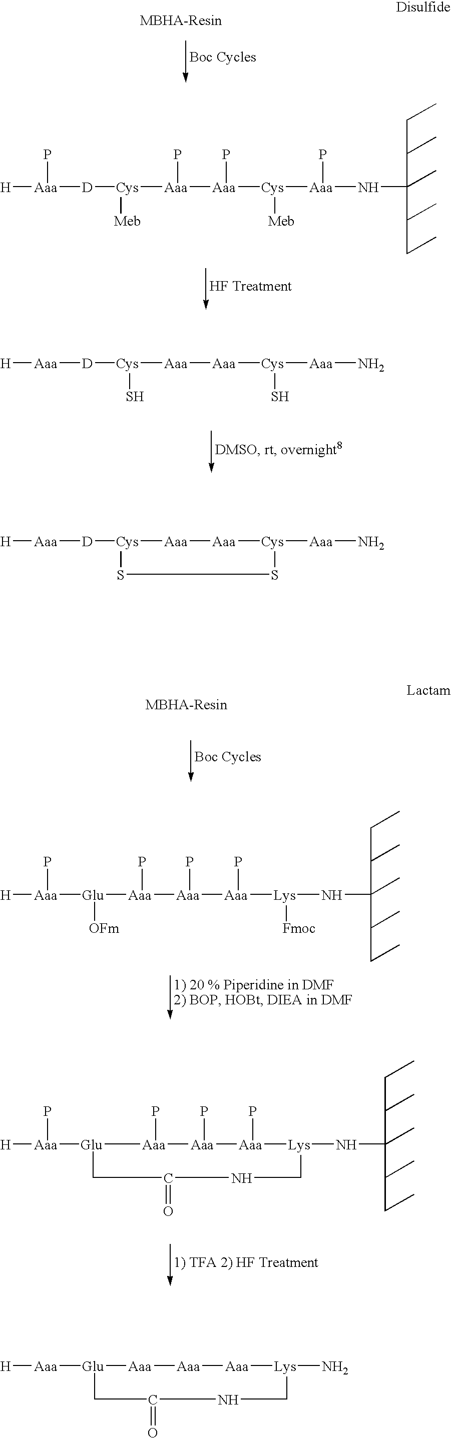

### Biological Activity Data

The synthetic helicormimetic peptides designed as antagonists of the estrogen receptor-coactivator interactions were tested in a competition binding assay (Lilly Research Labs) against a model linear peptide sequence. Activities are reported in the Table below in Ki values, with two of the best analogs labeled as PERM-1 and PERM-2, or Peptidomimetic Estrogen Receptor Modulators.

TABLE I
Peptide Analogs and their Ki values against ER alpha and ER beta

| | | | | |
|---|---|---|---|---|
| | | | ER α | ER β |
| Title | Sequence | MW | μM | μM |

| | | | | |
|---|---|---|---|---|
| AML-I-22 | H-Leu-Glu-Gln-Leu-Leu-OH | 614.3 | N/A | 201.2 |
| AML-I-31 | Mannosylacetvl-Leu-Glu-Gln-Leu-Leu-OH | 818 | N/A | 339.4 |
| AML-I-48/4 | H-Lys-cyclo (D-Cys-Ile-Leu-Cys)-Arg-Leu-Leu-Gln-NH_{2 PERM-1} | 1085 | 0.025 | 0.39 |
| AML-I-61/2 | H-Lys-Lys-Ile-Leu-His-Arg-Leu-Leu-Gln-NH₂ | 1147 | 0.17 | 2.8 |
| AML-I-59/6 | K-Lys-cyclo(Glu-Ile-Leu-Arg-Lys)-Leu-Leu-Gln-NH₂ | 1120.7 | 0.22 | 4.8 |
| AML-I-71/2 | Ac-Lys-cyclo(D-Cys-Ile-Leu-Cys)-Arg-Leu-Leu-Gln-NH₂ | 1127 | 0.12 | 7.7 |
| AML-I-86/1 | Gu-Lys-cyclo-(D-Cys-Ile-Leu-Cys)-Arg-Leu-Leu-Gln-NH₂ | 1183 | 0.14 | 0.6 |
| AML-I-83/4 | Aib-Lys-cyclo(D-Cys-Ile-Leu-Cys)-Arg-Leu-Leu-Gln-NH₂ | 1172 | 0.13 | 1.4 |
| AML-I-89/2 | H-Lys-His-Lys-Ile-Leu-His-Arg-Leu-Leu-Gln-Asp-Ser-Ser-OH | 1573.9 | 0.38 | 6.9 |
| AKG-I-28 | H-D-Lys-cyclo (D-Cys-Ile-Leu-Cys)-Arg-Leu-Leu-Gln-NH₂ | 1085 | 0.22 | 1.9 |
| AKG-I-39 | H-Lys-cyclo (Ala-Ile-Leu-Ala)- Arg-Leu-Leu-Gln-NH₂, | 1053 | 1.18 | 15.4 |
| | Lanthionine | | | |
| AKG-I-40 | H-D-Lys-cyclo (AIa-Ile-Leu-Ala)- Arg-Leu-Leu-Gln-NH₂, | 1053 | 3.95 | 13.5 |
| | Lanthionine | | | |
| AKG-I-46 | H-Lys-Leu-Leu-cyclo(D-Cys-Ile-Leu-Cys)-Arg-Leu-Leu-Gln- | 1311 | 0.398 | 2.0 |
| | NH₂ | | | |
| AKG-I-48 | K-Lys-cyclo(Cys-Ile-Leu-Cys)-Arg-Leu-Leu-Gln-NH₂ | 1085 | 0.416 | 1.8 |
| AKG-I-50 | H-Arg-cyclo(D-Cys-Ile-Leu-Cys)-Arg-Leu-Leu-Gln-NH_{2 PERM-2} | 1113 | 0.011 | 0.077 |
| AKG-I-59 | H-Lys-cyclo(Cys-Leu-Ile-D-Cys)-Arg-Leu-Leu-Gln-NH₂ | 1085 | 2.1 | 17.0 |
| AKG-I-60 | H-Lys-cyclo(Cys-Ile-Leu-D-Cys)-Arg-Leu-Leu-Gln-NH₂ | 1085 | 2.4 | 7.2 |
| AKG-I-61 | H-Lys-cyclo(D-Cys-Ile-Leu-D-Cys)-Arg-Leu-Leu-Gln-NH₂ | 1085 | 0.928 | 3.9 |
| AKG-I-63 | H-Lys-cyclo(Cys-Leu-D-Cys)-Arg-Leu-Leu-Gln-NH₂ | 972 | 2.2 | 7.9 |
| AKG-I-64 | H-Lys-cyclo(D-Cys-Leu-D-Cys)-Arg-Leu-Leu-Gln-NH₂ | 972 | 1.8 | 5.2 |
| AKG-II-1 | H-Arg-cyclo (D-Cys-Leu-Ile-Cys)-Arg-Leu-Leu-Gln-NH₂ | 1113 | .013 | .216 |
| AKG-II-3 | H-Arg-cyclo (D-Cys-Ile-Leu-HomoCys)-Arg-Leu-Leu-Gln-NH₂ | 1127 | .013 | .214 |
| AKG-II-4 | H-Arg-cyclo (DHomoCys-lIe-Leu-Cys)- Arg-Leu-Leu-Gln-NH₂ | 1127 | .035 | .591 |
| AKG-II-8 | H-Arg-cyclo (Cys-Ile-Leu-Arg-Cys)-Leu-Leu-Gln-NH₂ | 1113 | .174 | 1.16 |
| AKG-II-9 | H-Arg-cyclo (D-Pen-Ile-Leu-Cys)-Arg-Leu-Leu-Gln-NH₂ | 1141 | .168 | .933 |
| AKG-II-10 | H-Arg-cyclo (D-Cys-Ile-Leu-Pen)-Arg-Leu-Leu-Gln-NH₂ | 1141 | .088 | 1.91 |
| AKG-II-11 | H-Arg-cyclo(D-Pen-Ile-Leu-Pen)-Arg-Leu-Leu-Gln-NH₂ | 1169 | .078 | 3.97 |
| SRC-1 NR2 | LTERHKILHRLLQEGSPSD | | 0.39 | — |

Short linear peptides that contain the LXXLL sequence, such as Leu-Asn-Gln-Leu-Leu, do not display any inhibitory activity with respect to the desired effect of inhibiting the binding of the estrogen receptors to the helical segment of coactivator proteins.

As seen in the Table, compounds that contain a D-Cys, L-Cys pairing are especially active with respect to binding inhibition.

A report by Geistlinger ad Guy teaches of the inhibition of the interaction between thyroid hormone and its interaction using side chain to side chain linked peptides. The ring in this example is formed through an amide linkage between a lysine residue and a glutamic acid residue. But this report does not include any examples of disulfide bridges nor of the preference for a D-cysteine and L-cysteine pairing, nor does it include any examples of receptors other than the thyroid nuclear receptor.

X-Ray Structure of a Helicomimetic Peptide Bound to the Estrogen Receptor Dimer Ligand Binding Domain (LBD)

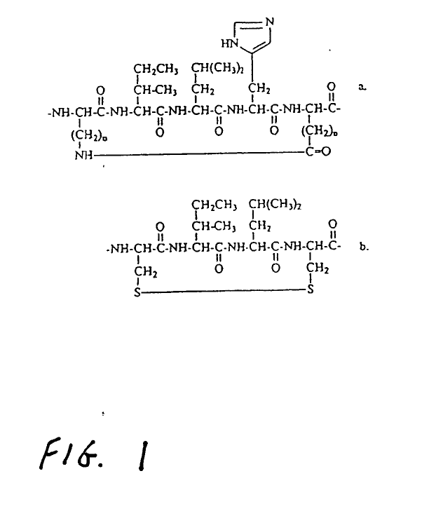

The conditions for the cyrstallization of the peptide protein complex as shown in FIG. 1 are describes as follows:

Cloning of the Gene Expression and Purification of Human ER LBD.

The ER LBD gene was overexpressed in E. coli and purified by Pan Vera, Inc.

Crystallization.

Diffraction-quality crystals of the ER LBD complex were grown by the vapor diffusion technique at 294K using a Hampton (Hampton Research Inc.,) crystallization screen. Crystals belong to orthorhombic space group C222₁, with unit cell parameters a=53.8 Å, b=102.4 Å, c=195.3 Å. There are two molecules of the complex per asymmetric unit, with a Vₘ value (Matthews 1968) of 2.28 Å³/Da that corresponds to a solvent content of approximately 46% in both cases. The 17-estradiol and PERM-1 (peptide) in 2-3 fold of excess of the protein were used for co-crystallization.

Data Collection, Structure Solution, and Crystallographic Refinement.

The diffraction data resolution of (resolution of 2.7 Å; R_{merge}=0.114, and completeness of 95%) were collected using a MarCCD (refmar) detector on IMCA (Industrial Macromolecular Crystallography Association) beam line BM-17 at the APS (Advanced Photon Source, Argonne National Laboratories) at 100K, using 15-20% glycerol as a cryoprotectant. The diffraction data were reduced using HKL2000 (Otwinowski and Minor 1997) and the intensities were scaled with SCALEPACK. Crystal structure was determined by the method of molecular replacement using the AMORE program suite (CCP4; Collaborative Computing Project #4 1994). The crystal structure was refined against data between 20-2.7 Å using a maximum likely-hood algorithm as incorporated in the program CNX2000 (Badger et al., 1999) (R_{work}=0.203, R_{free}=0.258, RMS=0.007 Å) (Brünger 1992). The program suite QUANTA 98 (Molecular Simulation Inc., San Diego, Calif.) was used for visual inspection and manual corrections between rounds of refinement. An analysis of the geometry showed all parameters were within the values expected for a model at this resolution. All residues were found in the most favorable and additionally allowed regions of a Ramachandran plot.

The omitted unbiased electron density map was used for positioning 17β-estradiol and the PERM-1 peptide.

Specific compositions, methods, or embodiments discussed are intended to be only illustrative of the invention disclosed by this specification. Variation on these compositions, methods, or embodiments are readily apparent to a person of skill in the art based upon the teachings of this specification and are therefore intended to be included as part of the inventions disclosed herein.

Reference to documents made in the specification is intended to result in such patents or literature cited are expressly incorporated herein by reference, including any patents or other literature references cited within such documents as if fully set forth in this specification.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented hereinabove. Rather, what is intended to be covered is within the spirit and scope of the appended claims.

1. A helicomimetic compound for stabilizing the alpha helical structure of a protein fragment which can serve as an agonist or antagonist of protein-protein interactions, comprising:
a compound consisting of the structure R1-(Xn)-D-Cys-Y-Y-L-Cys-(Xn)-R2, where R1 consists of H, an alkyl, aryl, acetyl, formyl, or other blocking or solubilizing group such as a polyethylene glycol (PEG) or other polyether moiety, linked to the N-terminal nitrogen through a carbon-nitrogen bond;
said X comprises one or more natural or unusual amino acids, linked together in a chain from 0 to n in length;
said Y comprises a selected natural or unnatural amino acid, usually of the L-configuration, and with two such amino acids that need not be identical, separating the pairs of cysteines to form an i to i+3 type of disulfide bridged unit; and
R2 comprises a selected OH, NH2, NHR, or, OR other blocking or solubilizing group such as polyethylene glycol (peg) or other polyether moiety, linked to the c-terminal carbonyl through an oxygen or carbon or nitrogen linkage, such as an amide group.

2. A compound comprising a structure, wherein, R1 is (Xm)-D-Cys-Y-Y-L-Cys-(Xn)-R2, wherein Y-Y is selected from the group consisting of Ile and Leu;
said Xm comprises one or more natural or unusual amino acids, linked together in a chain from 0 to n in length; and
said Xn is selected from the group consisting of Leu-Leu, or Leu-Leu-Xm.

3. A compound comprising the structure R1-(Xm)-D-Aaa-Y-Y-L-Aaa-(Xn)-R2, wherein
said Aaa comprises a cysteine, homocysteine, penicillamine, or other amino acid with a thiol side chain suitable for the formation of disulfide bridges;
said Xm comprises one or more natural or unusual amino acids, linked together in a chain from 0 to n in length;
said Y-Y is selected from the group consisting of Ile and Leu;
said Xn is selected from the group consisting of Leu-Leu, Leu-Leu-Xm, and combinations thereof.

4. The compound of claim 1, wherein said compound is combined with a selected bioconjugate carrier to increase the the solubility, transport and delivery of said helicomimetic for use as a drug.

5. The compound of claim 2, wherein said compound is combined with a selected bioconjugate carrier to increase the the solubility, transport and delivery of said helicomimetic for use as a drug.

6. The compound of claim 3, wherein said compound is combined with a selected bioconjugate carrier to increase the the solubility, transport and delivery of said helicomimetic for use as a drug.

7. The compound of claim 1, wherein the compound is linked to a bioconjugate selected from a group consisting of a polyethylene glycol, an alkylated C-sugar, a transport peptide, and combinations thereof.

8. The compound of claim 2, wherein the compound is linked to a bioconjugate selected from a group consisting of a polyethylene glycol, an alkylated C-sugar, a transport peptide, and combinations thereof.

9. The compound of claim 3, wherein the compound is linked to a bioconjugate selected from a group consisting of a polyethylene glycol, an alkylated C-sugar, a transport peptide, and combinations thereof.

10. The compound of claim 1, said compound containing an amide bond replacement selected from a group consisting of a singly bonded carbon-carbon, double bonded carbon-carbon, a carbon-sulfur, a carbon-nitrogen between pairs of amino acids in order to render said compound more resistant to enyzmatic degradation.

11. The compound of claim 2, said compound containing an amide bond replacement selected from a group consisting of a singly bonded carbon-carbon, a double bonded carbon-carbon, a carbon-sulfur, a carbon-nitrogen between pairs of amino acids in order to render said compound more resistant to enyzinatic degradation.

12. The compound of claim 3, said compound containing an amide bond replacement selected from a group consisting of a singly bonded carbon-carbon, a double bonded carbon-carbon, a carbon-sulfur, a carbon-nitrogen between pairs of amino acids in order to render said compound more resistant to enyzmatic degradation.
